(19) United States
(12) Patent Application Publication
(10) Pub. No.: US 2014/0272054 A1
(43) Pub. Date: Sep. 18, 2014

(54) SYSTEM AND METHOD FOR DE-STEMMING PRODUCE AND PREPARING PRODUCE FOR DE-STEMMING

(71) Applicant: Nagendra B. Kodali, Pelham, NH (US)

(72) Inventor: Nagendra B. Kodali, Pelham, NH (US)

(21) Appl. No.: 14/206,380

(22) Filed: Mar. 12, 2014

Related U.S. Application Data
(63) Continuation-in-part of application No. 13/829,529, filed on Mar. 14, 2013.

(51) Int. Cl. A23N 15/02

(52) U.S. Cl. CPC A23N 15/02
USPC 426/484; 99/640

(57) ABSTRACT

Systems and methods of at least partially de-stemming produce are provided. A de-stemming apparatus can include a plurality of roller pairs defining a longitudinal gap between individual rollers of the roller pairs. The roller pairs can to rotate to pass the produce through the longitudinal gap and apply a compression force to the produce. The de-stemming apparatus can include drum assembly having at least one of a shaft and a drum. At least one of the shaft and the drum can include protrusions to apply a blunt force to the produce to at least partially separate a first portion of the produce from a second portion of the produce.

### CROSS REFERENCE TO RELATED APPLICATION

This application is a continuation-in-part of and claims priority under 35 U.S.C. §120 to U.S. patent application Ser. No. 13/829,529, filed on Mar. 14, 2013, titled “SYSTEM AND METHOD OF DE-STEMMING PRODUCE AND PREPARING PRODUCE FOR DE-STEMMING”, which is herein incorporated by reference in its entirety.

### BACKGROUND

Agricultural products can be harvested manually or with the aid of harvesting machines. When agricultural products are harvested from a field, the agricultural products can be processed and distributed to consumers for consumption.

### SUMMARY

At least one aspect is directed to a system of de-stemming produce having a first portion and a second portion. A plurality of roller pairs can define a longitudinal gap between individual rollers of the roller pairs. The plurality of roller pairs can rotate to pass the produce through the longitudinal gap and apply a compression force to the produce. A drum assembly can have at least one of a shaft and a drum. At least one of the shaft and the drum can include a plurality of protrusions that can apply a blunt force to the produce to at least partially separate the first portion from the second portion.

At least one aspect is directed to a de-stemming apparatus for at least partially de-stemming produce having a first portion and a second portion. A plurality of rollers can defining a longitudinal gap, and can rotate to pass the produce through the longitudinal gap and apply a compression force to the produce. The apparatus can include a drum assembly having a drum defining a cavity and a shaft at least partially disposed in the cavity. The drum can have a protrusion extending into the cavity, and the shaft can have a protrusion extending into the cavity. A drive unit can rotate at least part of the drum assembly to apply a blunt force to the produce.

At least one aspect is directed to a method of processing produce. The method can convey an item of produce having a first portion and a second portion through a gap between a first roller and a second roller to apply a compression force to the produce. The method can convey the item of produce from the gap between the first roller and the second roller into a cavity of a drum assembly having at least one of a drum and a shaft. At least one of the drum and the shaft can have a protrusion extending into the cavity. The method can rotate at least part of the drum assembly to apply a blunt force from the protrusion to the item of produce to separate the first portion of the produce from the second portion of the produce.

At least one aspect is directed to a de-stemming apparatus for at least partially de-stemming produce having a pod, a stem, and a calyx. The de-stemming apparatus can include a first roller pair including a first roller and a second roller. The first roller and the second roller can at least partially define a longitudinal gap and have a first distance between a surface of the first roller and a surface of the second roller. The de-stemming apparatus can include a second roller pair including a third roller and a fourth roller. The third roller and the fourth roller can at least partially define the longitudinal gap and can have a second distance between a surface of the third roller and a surface of the fourth roller. The second radial distance can be less than the first radial distance. The de-stemming apparatus can include at least one drive unit configured to drive the first roller and the third roller to rotate in a first direction, and to drive the second roller and the fourth roller to rotate in a second direction that is opposite the first direction to convey the produce through the longitudinal gap and apply a compression force to an area of the produce between the pod and the stem that at least partially separates the pod from at least a portion of the calyx and the stem during conveyance through at least part of the longitudinal gap.

At least one aspect is directed to a system of de-stemming produce having a pod, a calyx, and a stem. The system can include a plurality of roller pairs in a stacked configuration defining a longitudinal gap between individual rollers of the roller pairs. The system can include at least one drive unit configured to rotate the plurality of roller pairs to pass the produce through the longitudinal gap from an entry point of the longitudinal gap to an exit point of the longitudinal gap. The entry point of the longitudinal gap can have an opening (e.g., a cross sectional distance or width) that is greater than an opening (e.g. a cross sectional distance or width) of the exit point of the longitudinal gap. The system can include at least one roller pair of the plurality of roller pairs including a first roller configured to rotate in a first direction and a second roller configured to rotate in a second direction opposite the first direction to pass the produce through at least a portion of the longitudinal gap and to apply a compression force to an area of the produce that includes the calyx to loosen the pod from the calyx and the stem with the stem attached to the calyx. The system can include a drum assembly having a shaft and a plurality of protrusions, the shaft configured to rotate separate the pod from at least a portion of the calyx and the stem.

At least one aspect is directed to a method of processing produce. The method can convey an item of produce having a pod, a calyx and a stem through a de-stemming apparatus configured to at least partially de-stem the produce. The de-stemming apparatus can include a first roller configured to rotate in a first direction and a second roller configured to rotate in a second direction opposite the first direction to pass the produce through a longitudinal gap having a transverse axis within 20 degrees of a vertical axis between the first roller and the second roller, with a longitudinal axis of the produce aligned with the transverse axis. The method can apply a compression force to a portion of the produce that includes the calyx to partially separate the pod from the calyx and the stem, with the stem attached to the calyx.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. For example not all protrusions 515 have an individual identifier as in FIG. 12, among others. In the drawings:

FIG. 1 is an illustration depicting one example of an item of produce, according to an illustrative implementation;

FIG. 2 is a perspective view depicting one example of a de-stemming apparatus, according to an illustrative implementation;

FIG. 3 is a perspective view depicting one example of a de-stemming apparatus, according to an illustrative implementation;

FIG. 4 is a perspective view depicting one example of a de-stemming apparatus, according to an illustrative implementation;

FIG. 4A is a diagram depicting one example of a de-stemming apparatus, according to an illustrative implementation;

FIG. 5 is a perspective view depicting one example of a drum assembly of a de-stemming apparatus, according to an illustrative implementation;

FIG. 6 is an exploded view depicting one example of a drum assembly of a de-stemming apparatus, according to an illustrative implementation;

FIG. 7 is a perspective view depicting one example of a drum assembly of a de-stemming apparatus, according to an illustrative implementation;

FIG. 8 is a perspective view depicting one example of a drum assembly of a de-stemming apparatus, according to an illustrative implementation;

FIG. 9 is an illustration depicting one example of an item of produce, according to an illustrative implementation;

FIG. 10 is a flow diagram illustrating a method of processing produce, according to an illustrative implementation;

FIG. 11 is a perspective view depicting one example of components of a de-stemming apparatus according to an illustrative implementation;

FIG. 12 is a perspective view depicting one example of components of a de-stemming apparatus according to an illustrative implementation;

FIG. 13 is a perspective view depicting one example of components of a de-stemming apparatus according to an illustrative implementation;

FIG. 14 is a perspective view depicting one example of components of a de-stemming apparatus according to an illustrative implementation; and

FIG. 15 is a flow diagram illustrating a method of processing produce, according to an illustrative implementation.

### DETAILED DESCRIPTION

Following below are more detailed descriptions of various concepts related to, and implementations of, methods, apparatuses, and systems for processing produce. The various concepts introduced above and discussed in greater detail below may be implemented in any of numerous ways, as the described concepts are not limited to any particular manner of implementation. Examples of specific implementations and applications are provided primarily for illustrative purposes.

Agricultural products, e.g., produce such as fruits or vegetables, can be harvested from farms. The produce can be harvested or picked by farmers manually, with the use of harvesting machines, or using combinations thereof. When the produce is harvested, the edible portion of the produce can be picked from a plant together with additional portions of the plant that are generally not eaten. For example, a pepper having a pod (generally eaten) and a stem (generally not eaten) can be removed from a pepper plant with at least a portion of the stem still attached to the pod.

A de-stemming apparatus can loosen or separate the stem and other portions of the produce that are generally not eaten from the body or pod of the produce that is generally eaten. For example, the de-stemming apparatus can include at least one roller pair that includes a first roller and a second roller, as discussed herein. The produce can be placed in a longitudinal gap between the rollers of the roller pair. The rollers of the roller pair can rotate in opposite directions to catch the produce and carry or drive it deeper into the longitudinal gap, where for example the produce can encounter a second roller pair. In this example, the produce generally travels between the rollers of successive roller pairs. A radial distance of the longitudinal gap can narrow during travel between rollers of successive roller pairs.

During this travel the produce can be subjected to pressure or a compression force in the area of the calyx of the produce, or generally where the pod connects with the stem. The compression force can loosen (e.g., partially separate) the calyx or the stem from the pod. The produce, having the loosened or partially separated stem can be provided into a drum assembly. The drum assembly can include a drum having a shaft with one or more protrusions protruding from the shaft, from the drum, or from both the shaft and the drum. The shaft, the drum, or both can rotate to cause the protrusions to mix the produce or apply a blunt force to at least a portion of the produce. The blunt force to the produce can be caused by direct contact between the protrusions (or the shaft or the inner surface of the drum) and the produce, or due to contact between different items of produce as they are tossed around within the drum due to the shaft, protrusion, or drum rotation. The blunt force can fully separate the stems or the calyx from the pod of the produce, for example after the compression force applied by rollers loosens or partially separates at least a portion of the stem from the produce.

FIG. 1 illustrates an example of an item of produce 100. As illustrated in the example of FIG. 1, the produce 100 is a pepper, although the produce 100 can be other agricultural products such as fruits, vegetables, tomatoes, lemons, citrus, olives, carrots, eggplant, cucumbers, zucchini, squash, melons, peas, beans, legumes, tubers, onions, radishes, beats, strawberries, bananas, corn, apples, pears, peaches, plums grapes, lettuce, celery, or mushrooms for example. The produce 100 can generally include a commercial crop or agricultural product harvested for human consumption. In some implementations the produce 100 is a dry (or dried) pepper such as a whole red chili pepper. The produce 100 can be a chili pepper or other fruit from the capsicum genus or other pepper variety.

The produce 100 can include a first portion 105 and a second portion 110. The first portion 105 can include a body or pod 115 of the produce 100 having a tip or tip portion 130, and the second portion 110 can include at least a portion of the stem 120 or the calyx 125 of the produce 100, with the pod 115 generally being the edible portion of the produce 100. The stem 120 and the calyx 125 (while perhaps being edible) are generally the portions of the produce 100 that are not eaten. For example, the stem 120 can include the portion of the produce 100 that at least partially supports the produce 100 prior to harvesting from a plant, and the calyx 125 can include sepals or other structure between the outer surface of the pod 115 and the stem 120. The calyx 125 can include a cup shaped structure that attaches the stem 120 with the pod 115 or that covers at least a portion of the pod 115. The produce example, the produce 100 can have an elliptical or elongated shape, such as certain varieties of pepper or chili pepper with a generally elongated pod 115 and rounded or pointed tip portion 130 opposite the longitudinal end of the stem 120 and calyx 125.

FIG. 2 and FIG. 3 illustrate examples of a de-stemming apparatus 200. The de-stemming apparatus 200 can loosen or partially separate the first portion 105 of the produce 100 from the second portion 110 of the produce 100. For example, the de-stemming apparatus 200 can process the produce 100 to loosen at least part of the stem 120 or the calyx 125 from the pod 115.

In some implementations, the de-stemming apparatus 200 includes at least one roller 205a and at least one roller 205b. The rollers 205a, 205b (sometimes collectively referred to as rollers 205) can include a cylinder or have a cylindrical body. The rollers 205a can be disposed in a stacked configuration with one roller 205a above or on top of another roller 205a, as in FIG. 2, in a generally vertical configuration. The rollers 205b can also be disposed in a stacked, generally vertical configuration as in FIG. 2 and FIG. 3, where the top or first roller 205b is visible.

Lateral ends of the rollers can be coupled with at least one mounting structure 210. For example, shafts 215 of the rollers 205 can extend into or through the mounting structure 210 and can couple with at least one drive unit 220. In some implementations, at least one drive unit 220 is configured to drive the rollers 205. The drive unit 220 can include at least one AC or DC motor coupled to at least one shaft 215 connected to at least one of the rollers 205. At least one drive unit 220 can rotate at least one shaft 215 to rotate or spin the respective rollers 205. In one implementation, at least one belt 225 couples the drive unit 220 with the shafts 215 so that operation of the drive unit 220 causes the rollers 205 to rotate or spin. The drive unit 220 can include or couple to a power supply. For example, the drive unit 220 can include one or more batteries or can plug into an outlet to connect to a power grid. The shaft 215 can be an integral part of the roller 205. In some implementations, one or more than one drive unit 220 causes the rollers 205 to rotate at substantially (e.g., +/−10%) the same rate, speed, or velocity for example in terms of revolutions per minute or other unit. In some implementations, the drive unit 220 is a 0.5 to 1.0 horsepower motor. The drive unit 220 can also be significantly more powerful than 1.0 horsepower, for example by one, two, or more orders of magnitude. The drive unit 220 can be connected via a shaft to a bottom roller 205 that is coupled to the belt 225 to rotate multiple rollers 205. In some implementations, a single drive unit 220 and a single shaft 215 (or in some examples more than one shaft 215) can rotate the rollers 205a, 205b. In one embodiment, multiple drive units 220 and multiple shafts 215 can drive the rollers 205a, 205b. In some implementations the belt 225 can include (or be replaced with) a combination of belts, sprockets, chains, pulleys, timing belts, or O-rings to transfer mechanical force from the drive unit 220 to the rollers 205.

In one implementation, the rollers 205 are configured in the mounting structure 210 in a modular fashion. For example, individual rollers 205 can be inserted into or removed from the mounting structure 210 for repair, maintenance or de-stemming apparatus 200 adjustment purposes. In some implementations, the position of the rollers 205 in the mounting structure 210 can be adjusted, for example to tighten to loosen the belt 225, in order to transfer mechanical force from the drive unit 220 to the rollers 205, or to adjust or replace the belt 225. In one implementation, for example to facilitate assembly of the de-stemming apparatus 200, individual roller pairs can be provided as a single unit. For example, one roller 205a, one roller 205b, and a corresponding portion of the mounting structure 210 into which lateral ends of each of the rollers 205a, 205, are coupled can be provided as a modular unit. The modular units can be stacked together with respective mounting structures 210 interlocking with each other (or otherwise fixed together, e.g., via screws, clamps, or inserts) to form the complete mounting structure 210 of the de-stemming apparatus 200.

In some implementations, at least one drive unit 220 rotates the rollers 205 at different rates. For example, rollers 205a can rotate faster or slower than rollers 205b, or different roller pairs can rotate at different rates. For example, a roller pair at the top of the de-stemming apparatus 200, e.g., the first roller pair to receive the produce 100 travelling in the direction of motion 245, can operate at a faster rate or a slower rate than a subsequent roller pair that is configured to subsequently receive the produce 100.

The de-stemming apparatus 200 can include at least one base structure 230. The base structure 230 can support the mounting structure 210 and the drive unit 220. The size of the de-stemming apparatus 200 can vary. In some implementations, the rollers 205 are less than 24 inches in length and have a diameter of less than three inches. For example, the de-stemming apparatus 200 can be a portable or semi-portable unit (e.g., for lower volume processing) that can be transported to a farm, harvesting area, or processing center to at least partially de-stem the produce 100. The de-stemming apparatus 200 for example can be disposed on or fixed (e.g., via clamps) to a table, counter top, work area, or the ground. The rollers 205 can also have larger dimensions, such as a length of more than 24 inches, with a diameter less than, greater than, or substantially three inches (e.g., +/−one inch). In one implementation, the de-stemming apparatus is a generally permanent structure in a food processing environment having rollers 205 of several feet in length or more. In this example, the de-stemming apparatus 200 can be constructed for high volume produce processing. In one implementation, the de-stemming apparatus 200 can processes up to 250 kilograms (or more in some examples) of produce 100 such as dry red chili peppers per hour, rather than the 30 kilograms total that a manual laborer (e.g., a human) can process in one 8 hour day. In one implementation, a combination of four (or other number) of the de-stemming apparatus 200 can operate simultaneously to process one metric ton of the produce 100 per hour. For example, multiple de-stemming apparatuses 200 can be lined up end to end in a modular fashion, or otherwise put together to operate simultaneously to increase produce processing capacity.

In some implementations, the drive unit 220 rotates at least one roller 205. For example, the drive unit 220 can couple with the belt 225 that is also coupled with at least one shaft 215. Operation of the drive unit 220 can, for example, spin a motor that rotates a motor shaft or gear (not directly depicted in FIG. 2) coupled with the belt 225 that in turn is coupled with the shaft 215 or roller 205 to rotate the roller 205. Driving elements other than the belt 225 are possible. For example, a system of gears can transfer mechanical power from the drive unit 220 to the rollers 205 to rotate the rollers 205. In one implementation, the de-stemming apparatus include a single drive unit 220 to rotate at least one roller 205.

The de-stemming apparatus 200 can include one or more than one drive unit 220. For example, one drive unit 220 can transfer mechanical power to rotate all or more than one of the rollers 205. In some implementations, one or more rollers 205 can have a dedicated drive unit 220. Control systems of multiple drive units 220 can electronically communicate with each other, or can receive instructions from a common control system to coordinate or control the rotational speed (e.g., revolutions per minute) of the rollers 205.

In some implementations, a roller 205a and a roller 205b can be referred to as a roller pair. The roller pair generally includes one roller 205a and one roller 205b. The pair of rollers 205a, 205b can be a coplanar set of rollers 205a, 205b that are generally proximate to each other in a generally parallel configuration. For example, referring to FIG. 2 the top or upper roller 205a and top or upper roller 205b (the only roller 205b directly visible in FIG. 2) can be referred to as a roller pair. In the example of FIG. 2, this is the only roller pair with both rollers 205a, 205b visible. The de-stemming apparatus 200 can include any number of pairs of rollers. For example, each of the five rollers 205a in FIG. 2 (stacked in a generally vertical configuration in this example) can have a corresponding roller 205b, also stacked in a generally vertical configuration. In one implementation, the de-stemming apparatus 200 includes at least four roller pairs, e.g., at least eight rollers 205. In some implementations, the de-stemming apparatus 200 includes five or six roller pairs.

In some implementations, the drive unit 220 controls rollers 205a, 205b of a roller pair to rotate in opposite directions. For example, the drive unit 220 via the belt 225 can control the roller 205a of a roller pair to roll in a clockwise direction, and the same or a different drive unit 220 can control the roller 205b (the other roller of the same roller pair) to roll in a counterclockwise direction (or vice versa) when both rollers 205a, 205b are viewed from the same position, such as a lateral end, or viewing the shafts 215 of the rollers 205a, 205b. For example, the drive unit 220 can rotate at least one roller 205a in direction 235 and can rotate at least one roller 205b in direction 240.

In some implementations, each roller 205a is configured to rotate (or spin) in the direction 235 and each roller 205b is configured to rotate (or spin) in the direction 240. The rollers 205 can be actively driven to rotate by the drive unit 205 or passively driven to rotate, for example, by the force of the produce 100 that comes into contact with the rollers 205. In one implementation, the produce 100 that contacts the pair of rollers 205a, 205b simultaneously rotating in opposite directions drives the produce 100 downward (from the example perspective of FIG. 2) in the direction of motion 245 between the pairs of rollers 205a, 205b. This motion or conveyance of the produce 100 can be caused by the rotational force of the rollers 205a 205 contacting the produce 100. In some implementations, gravitational or friction forces also at least partially moves or drives the produce between the pairs of rollers 205a, 205b. When travelling between rollers 205a, 205b of a roller pair, the produce 100 can encounter compression forces. For example, the oppositely rotating rollers 205a, 205b of a roller pair can drive the produce 100 through a gap between the roller pair. At least portions of the produce 100, such as an area of the produce 100 near the calyx 125, or where the first portion 105 contacts the second portion 110 can be larger than the gap between rollers 205a, 205b. This or other portion of the produce 100 can be exposed to a compression force (e.g., a converging pressure force) that can at least partially separate (e.g., loosen) the first portion 105 from the second portion 110. In some implementations, at least one roller pair is configured to rotate, with each roller 205a, 205b rotating in opposite directions, to apply a compression force to an area of the product 100 between the calyx 125 and the pod 115. The compression force can loosen the stem 120 and the calyx 125 from the pod 115, for example with the stem 120 still attached to the calyx 125 with the produce 100 in the loosened or partially separated state.

FIG. 4 is a perspective view depicting an example of the de-stemming apparatus 200. Referring to FIG. 4, a top or first roller pair of rollers 205a, 205b is generally illustrated. Four additional roller pairs are also illustrated, as indicated by their respective shafts 215. In one implementation, the longitudinal lengths of the rollers 205a, 205b at least partially define a longitudinal gap 405. The longitudinal gap 405 can include the space or opening between respective rollers 205a, 205b of a roller pair. The length of the longitudinal gap 405 generally includes the longitudinal length of the rollers 205 that are configured to receive or contact the produce 100 during processing, such as generally the length of the rollers 205 between the mounting structures 210. In one implementation, the length of the longitudinal gap 405 is substantially constant, e.g., the length of the longitudinal gap 405 defined by one roller pair with within +/−10% of the length of the longitudinal gap 405 defined by another roller pair.

The width 410 of the longitudinal gap 405 can include a radial distance between surfaces of two rollers 205a, 205b of a roller pair. The radial distance, (which may also be referred to using identifier 410) for example, can be the closest distance between an outer surface of a roller 205a and an outer surface of the corresponding roller 205b of one roller pair, e.g., a measurement indicating how close two rollers 205a, 205b of a roller pair are to each other at their closes point.

The radial distance 410 of one longitudinal gap 405 can vary. For example, the radial distance 410 can range from 20 mm at the top of the de-stemming apparatus 200 (e.g., the point of entry of the produce 100, or the radial distance between a top or first roller pair 205a, 205b of the de-stemming apparatus 200) to 0.5 mm at the bottom of the de-stemming apparatus (e.g., the point of exit of the produce 100 from the de-stemming apparatus 200, or the radial distance between a bottom, second, or last roller pair 205a, 205b). In one implementation, the longitudinal gap 405 has a first radial distance 410 of 15 mm (+/−10%) between one roller pair, and a second radial distance of 1-2 mm (+1/−10%) between another roller pair of the de-stemming apparatus 200. In one implementation, the longitudinal gap 405 has a first radial distance 410 of between 10-20 mm (+/−10%) between one roller pair, and a second radial distance of 0.5-2.5 mm (+1/−10%) between another roller pair of the de-stemming apparatus 200. The roller pair with the larger radial distance 410 can process the produce 100 before the roller pair with the smaller radial distance 410. The de-stemming apparatus 200 can include additional or intervening rollers pairs before, after, and between the two roller pairs of this example.

In one implementation, the radial distance 410 decreases between roller pairs as the produce 100 passes through the longitudinal gap (e.g., generally transversely, vertically, or from top to bottom along the direction of motion 245, as in FIG. 2). In this example, the radial distance 410 between each roller pair in the direction of motion 245 can be less than the radial distance 410 of the previous direction of motion. The passing of the produce 100 through a decreasing radial distance 410 can squeeze, or apply a pinching or compression force to the produce 100. The compression force can at least partially separate (e.g., loosen) the first portion 105 from the second portion 110. For example, as the produce 100 passes through the decreasing radial distance 410 of the longitudinal gap 405, a relatively bulky or wide part of the produce, such as the area of the calyx 125, or the area where the stem 120 contacts the pod 115, can be greater than the radial distance 410 between two rollers 205a, 205b. The rollers 205, rotating in a substantially fixed position, can forcibly compress this or another area of the produce 100 as the produce 100 passes through or crosses the radial distance 410. The compression force applied by at least two rollers 205a 205b of one roller pair can partially separate or detach (e.g., loosen) the pod 105 from the stem 120 or from the calyx 125, for example with the stem 120 still at least partially attached to the calyx 125. In one implementation, the compression force fully separates the first portion 105 of the produce 100 from the second portion 110 of the produce, for example by removing the stem 120 and at least part of the calyx 125 from the pod 115.

The partially separated second portion 110 of the produce can still be physically attached, at least partially, to the first portion 105. For example, the stem 120 or calyx 125 can still be connected to the pod 105, with the structural connection weaker than it was prior to processing by the de-stemming apparatus. In this example, the partially separated second portion 110 is loose and can fully separate from the first portion due, for example, to gravitational forces when one holds the stem 125 and lets the pod 115 dangle, holds and mildly shakes the stem 125, or holds the stem and applies a mild blunt force to the pod 115. The partial separation between the first portion 105 and the second portion 110 of the produce 100 can include a partial peeling or popping off of the calyx 125 from the pod 115. The produce 100 in a partially separated state can exit the de-stemming apparatus 200 for further processing, storage, or shipping. For example, combinations of gravitational forces, a guide plate, conveying unit, manual laborer, or at least one roller pair (e.g., the bottom pair of rollers 205a, 205b) can expel or carry the produce out of or away from an exit point of the de-stemming apparatus 200. In this example, the produce 100 in the partially separated or loosened state can exit from the bottom of the longitudinal gap 405.

FIG. 4A depicts an example end view of de-stemming apparatus component operation. In this example, the de-stemming apparatus 200 includes three roller pairs, referred to in this example as a top roller pair, a middle roller pair, and a bottom roller pair of rollers 205a, 205b. For example, the top roller pair has a first roller 205a and a second roller 205b; the middle roller pair has a third roller 205a and a further roller 205b; and the bottom roller pair has a fifth roller 205a and a sixth roller 205b. The de-stemming apparatus 200 may include more or fewer roller pairs, with each roller pair having a roller 205a and a roller 205b. Each pair in this example includes one roller 205a and one roller 205b disposed generally proximate to each other in the horizontal direction 415. The produce 100 in this example can be an elongated dried or partially dried chili pepper, e.g., a picked pepper that has at least partially dried (naturally by hanging or laying out in an exposed manner, or induced to dry with a dryer unit prior to entry into the longitudinal gap 405. The dried produce 100 can be withered and shriveled or partially compressed or collapsed with respect to the relatively plump state of fresh produce. The produce 100 in some examples can be fresh and need not be dried. The produce can enter the longitudinal gap 405 in the direction of motion 245, (e.g., between the rollers 205a, 205b of the first or top roller pair at the top of the image) and can travel downward in the direction of motion 245 along the vertical axis 420 between successive roller pairs. In one implementation, the respective roller pairs are horizontally offset by a few millimeters (e.g., 3-10 mm) along the horizontal axis 415 to create a slithering like motion when the produce 100 passes through the longitudinal gap 405 in the direction of motion 245. In some implementations, a vertical stack of rollers (e.g., the rollers 205a, or the rollers 205b) can be vertically offset by a few millimeters (e.g., 3-10 mm) along the vertical axis 420 to impart a non-linear or curvy motion to the produce 100 as the produce 100 passes through the longitudinal gap 405 in the direction of motion 205. In some implementations, the rollers 205a, 205b can be offset both vertically (e.g., with respect to a previous or successive roller in a stack) and horizontally (e.g., with respect to a corresponding roller 205a, 205b of a roller pair). The horizontal or vertical offsetting can assist with the traction or driving of the produce 100 through the longitudinal gap 405.

With continued reference to FIG. 4A, among others, the rollers 205a are rotating in the direction of motion 235, (e.g., counterclockwise from the perspective of FIG. 4A) and the rollers 205b are rotating in the opposite direction of motion 240 (e.g. clockwise from the perspective of FIG. 4A). As the produce 100 passes the top roller pair 205a, 205b, the rotating surfaces of these and other rollers 205a, 205b can contact portions of the produce 100. This contact can guide the produce 100 further in the direction of motion 245 into the longitudinal gap 405, where the radial distance 410 gets successively narrower, e.g., from 15 mm (+/−10%) between the top roller pair and between 1-2 mm (+/−10%) at the bottom roller pair. In some implementations gravitational forces together with the rotational force of the rollers 205a, 205b or frictional force guide the motion of the produce 100 generally downward in the direction of motion 245 along the vertical axis 420.

In some implementations, the produce 100 is aligned to enter the longitudinal gap 405 tip first, (e.g., starting with the tip 130). For example a feeding apparatus (e.g., a ramp, funnel, manual laborer, or conveyor) can align the produce 100 with a longitudinal axis of the produce substantially aligned with a transverse axis of the longitudinal gap 405, (e.g., an axis within 30 degrees of the vertical axis 420 to feed the produce into the de-stemming apparatus 200), as for example in FIG. 4A. The produce 100 can enter and pass through the longitudinal gap 405 in any orientation, and need not be aligned in a substantially vertical position as in the previous example. For example, the produce 100 can randomly enter and pass through the longitudinal gap 405 in a non-organized or unsorted matter with no automated or manual attempt to align the produce 100 into any particular orientation prior to entry in to the longitudinal gap 405.

In some implementations, the roller pairs are stacked in a substantially vertical configuration, for example, with one roller pair above or below another roller pair. For example, stacked rollers 205a can be stacked along axis 425, and stacked rollers 205b can be stacked along axis 430. The roller pairs (such as the top, middle, and bottom roller pairs as in FIG. 4A in a stacked configuration along axes 425, 430 can be considered as stacked in a substantially vertical configuration when the axes 425, 430 deviate from the vertical axis 420 for example by 30 degrees or less, although deviances in the stacked configuration of rollers 205 of more or less than this range are possible. For example the rollers 205 can be stacked alone one of axes 425, 430 within 45 degrees of the vertical axis 420. The surfaces of rollers 205a, 205b of successive roller pairs (e.g., a first roller 205a of the top roller pair and a second roller 205a of the middle roller pair, or first and second rollers 205b of two successive roller pairs) in a stacked configuration may touch each other, or may be separated from each other by a distance of 20 mm or less, for example. In one implementation, the axes 425, 430 lie on intersecting planes that intersect at an angle of 30 degrees or less. In the vertical configuration depicted for example in FIGS. 2-4A, the de-stemming apparatus 200 takes advantages of gravitational forces to at least partially move the produce 200 and in one embodiment does not require a conveyor belt to move the produce 100 past the rollers 205, into or through the longitudinal gap 405.

In some implementations, the radial distance 410 at successive roller pairs decreases along the direction of motion 245 (e.g., from top to bottom, where the produce 100 enters the de-stemming apparatus 200 at the top). For example, the radial distance 410 of the bottom roller pair can be less than the radial distance 410 of the middle roller pair, and the radial distance 410 of the middle roller pair can be less than the radial distance 410 of the top roller pair. The reduction in the radial distance 410 along the direction of motion 245 (or along the generally vertical axis 420) can be caused by successive roller pairs being placed closer together in the de-stemming apparatus 205a, 205b. In this example, the rollers 205a, 205b with the same or a substantially similar (within manufacturing tolerance ranges) diameter or radius can be disposed in a generally V-shape configuration from an end perspective, as in the example of FIG. 4A, to define the longitudinal gap 405. In another example, the rollers pairs can be aligned in a parallel, rather than in a V-shape configuration, with successive roller pairs along the direction of motion 245 having a larger diameter or radius than a previous roller pair, so that the surfaces of the rollers 205a, 205b of successive roller pairs are closer to each other, reducing the size of the radial distance 410.

As the produce 100 passes through the continuously decreasing radial distance 410, a roller 205a and corresponding roller 205b of at least one roller pair can apply a compression force to at least a portion of the produce 100 as is passes the radial distance 410 of that roller pair. In one implementation, compression force from successive roller pairs increases. For example a first roller pair can apply a first compression force to the produce 100 as it passes the radial distance between rollers 205a, 205b of the first roller pair, and a second (subsequent or successive) roller pair can provide a second compression force to the produce 100 that is greater than the first compression force, due for example to the smaller radial distance 410 through which the produce 100 passes. The compression force can squeeze or compress at least a portion of the produce 100, depending for example on the shape of the produce 100. In one implementation, a portion of the produce 100, such as the area of the calyx 125, or the area where the stem 120 contacts the pod 115 may have a width or cross sectional diameter that is larger than the radial distance between two rollers 205a, 205b of a roller pair. In this example, forced passing due at least in part of the rotation of the rollers 205a, 205b of one or more roller pairs can force the produce 100 through or past the radial distance 410. When a bulkier part of the produce (e.g., at or near the calyx 125) passed through the smaller radial distance 410, the compression force applied by the rollers 205a, 205b, can partially separate (e.g., loosen) the connection between at least part of the calyx 125 and the pod 115, (or between any first portion 105 and second portion 110 of the produce 100).

In one implementation, the surface of at least one of the rollers 205a, 205b that can contact the produce 100 includes a textured surface. The textured surface, rather than a smooth surface, can have a fine pattern of dimples, bumps, or abrasive protrusions having the feel of fine grained sandpaper. The textured surface can increase the coefficient of friction (relative to a smooth surface) to provide traction or facilitate gripping, driving, drawing, or securing of the produce 100 as the produce 100 passes into, through, or out of the longitudinal gap 405. The frictional force generated by contact between the textured surface of one or more of the rollers 205a, 205b can drive the produce through the de-stemming apparatus 200. For example, the textured surface of one or more roller 205a, 205b combined with rotation force of the roller 205a in direction 235 or of the roller 205b in direction 240 can drive the produce in the direction of motion 245, (e.g., a direction within 45 degrees of the vertical axis 420, or another range such as within 20 degrees or within 30 degrees of the vertical axis 420. In some implementations, the produce 100 is generally elongated in shape, such as a chili pepper, and can be driven through the longitudinal gap 405 tip first, along a longitudinal axis of the produce 100 in a generally vertical orientation.

In one implementation, the textured surface includes a plurality of horizontal grooves along the longitudinal length of at least some of the rollers 205. The horizontal grooves of a roller 205, 205b can be generally parallel to each other, and can have a depth of less than a millimeter. The horizontal grooves, which may be created from a nulling operation, can provide traction to prevent the produce 100 from failing to pass through the longitudinal gap 405.

The rollers 205 can be made of metal, plastic, rubber, or combinations thereof. The textured surface of the rollers 205 can be made of the same material as the roller 205, e.g., metal or generally hard rubber, or the textured surface can be a laminate or overlay made of one material disposed on, attached to, or integral to the surface of the roller 205 that is made of a different material, such as a metal roller 205 having a rubber or plastic textured surface. In some implementations, the bottom two or three roller pairs include a textured surface to provide traction to move the produce through the longitudinal gap 205.

The partial separation of portions of the produce 100 can include a partial peeling of the calyx 125 from the pod 115, partial popping off of the calyx 125 (or other portion of the produce 100) or an internal weakening of the fibers or flesh of the produce 100 that hold the first portion 105 together with the second portion 110, e.g., a weakening of the structural connection. The partial separation can also include a loosening of the calyx 125 or stem 120 from the pod relative to its condition prior to entering the de-stemming apparatus 200, so that for example, the pod wiggles or completely separates when one holds the produce 100 by the stem 120 with the pod 115 dangling due to gravitational forces.

In some implementations, the produce 100 can be expelled from the de-stemming apparatus 200 due for example to gravitational forces when the produce 100 is driven past the last roller pair in the direction of motion 245. For example, the produce 100 can fall into a box or conveyor unit for further processing, quality assessment, cleaning, or distribution. In some implementations, a conveyor unit or apparatus can transport or carry the produce 100 for further processing, quality assessment, cleaning, or distribution.

FIG. 5 depicts an example of a drum assembly 500. FIG. 6 depicts an exploded view of the drum assembly 500. FIG. 7 and FIG. 8 depict perspective views of the drum assembly 500. The drum assembly 500 can be part of the de-stemming apparatus 200, or a separate unit. For example, a conveyor, ramp, guide, or plate can convey the produce directly or indirectly from an exit point of the longitudinal gap 405 into the drum 505 of the drum assembly 500. In some implementations, a manual laborer collects the produce after exiting the longitudinal gap 405 and provides the produce (e.g., in the partially separated state) into the drum 505.

The drum 505 generally has a hollow cavity into which the produce 100 in the partially separated state can be disposed. In one implementation, the drum 505 is cylindrical or barrel shaped, although the drum 505 can be differently shaped. The drum 505 can be made of metal, plastic or combinations thereof. In one implementation, the drum 505 is transparent so that drum assembly components and the produce 100 in the drum 505 are visible from outside the drum 505. The drum 505 can include a window, door, or opening for insertion and removal of the produce 100.

The drum assembly 500 can include at least one drum assembly shaft 510 protruding into the cavity of the drum 505. The shaft 510 can be made of metal or plastic, for example, and at least one protrusion 515 can protrude from the shaft 510 or from the drum 505 into the cavity at least partially defined by the drum 505. The protrusions 515 can be made of metal or plastic, and can be integral parts of the shaft 510, or separate components attached to the shaft 510, for example by screws, clamps, rivets, or clips. The protrusions 515 can protrude out from the shaft 510 into the cavity of the drum 505. Multiple protrusions 515 can extend from different sides of the shaft 510 along at least part of the length of the shaft 510 into the cavity of the drum 505, from the inner surface of the drum 505 into the cavity, or from both the shaft 510 and the drum 505 into the cavity.

FIG. 11 and FIG. 12 depict examples of the shaft 510 including the protrusions 515. FIG. 13 depicts an example of the drum 505 including the protrusions 515. FIG. 14 depicts an example of the drum assembly 500 with the drum 505 and the shaft 510 both including the protrusions 515.

The protrusions 515 can have a fin shape or different shapes, such as web, plate, finger, or rod shapes that protrude into the cavity of the drum 505. The protrusions 515 can be asymmetrical, cylindrical, quadrilateral, polygonal, straight, curved, s-shaped, linear, or non-linear. The protrusions 515 can have multiple linear segments, for example forming a zig-zag pattern. The protrusions 515 can have a longitudinal first portion and a head, fan, or bulbous shaped second portion, for example generally resembling a bolt, nail, or screw. Any protrusion from the shaft 510 or from the drum 505 that can contact the produce 100 disposed in the drum 505 can constitute the protrusions 515. The protrusions 515 can have a cross sectional shape that is square, rectangular, triangular, quadrilateral, circular, elliptical, or ovoid.

FIG. 11 and FIG. 12, among others, depict examples of the shaft 510. The shaft 510 can include one or more of the protrusions 515, protruding out from an outer surface of the shaft 510. The protrusions 515 can be an integral part of the shaft 510, or separate elements fastened, fixed, adhered, attached, welded, or mechanically coupled to the shaft 510. The protrusions 515 can be rods having a substantially uniform diameter or cross sectional width. In some implementations, the protrusions 515 have a body portion and an end portion. For example the body portion can have a rod, circular, or rectangular shape, and the end portion can have a head, fan structure, fingers, or a bulbous region that has a cross sectional distance that is greater than a cross sectional distance of the body portion. For example, the protrusions 515 can have the general shape of a nail, spike, or bolt that includes a body portion and an end portion.

The protrusions 515 can be disposed in various patterns on the shaft 510. For example, the protrusions 515 can be arranged in a number of annular or ring shaped patters around a radial distance of the shaft 510, or in a linear arrangement around a polygonal shaft 510, or in a number of rows along a longitudinal axis or length of the shaft 510. In one implementation, there are six rows of protrusions 515 extending from and along the longitudinal axis or length of the shaft 510. The protrusions 515 can vary in length. For example, the protrusions 515 can be between one inch and 12 inches in length. The protrusions 515 can also have a length greater than 12 inches. In some implementations, the protrusions 515 have a length of between 10% and 90% of the radius of the drum 505. In one implementation, the protrusions 515 have a length of greater than 50% of the radius of the drum 505. The protrusions 515 can be generally smooth, or can have a rough outer surface to increase friction with the produce 100 during contact with the produce 100. For example, the protrusions can have ridges, waves, dimples, sub-protrusions, a coarse outer surface, an uneven surface, etches, or other features to separate the first portion 105 and the second portion 110 of the produce 100.

The shaft 510 can have a diameter (or width or cross-sectional distance for a non-circular shaft 510) distance 1105. The distance 1105 can vary, for example, between two inches for smaller drum assemblies 500 and 36 inches or more for larger or higher volume drum assemblies 500. In some implementations, a narrow or small diameter (or distance 1105) shaft 510, when disposed in the cavity of the drum 505, can occupy less than 40% of the volume of the cavity. A broad or large diameter shaft 510, when disposed in the cavity of the drum 505 can occupy between 40% and 85% of the cavity.

FIG. 13 depicts an example of the drum 505 including the protrusions 515 extending into the cavity of the drum 505, from an inner surface of the drum 505. The protrusions 515 can be an integral part of the drum 505, or separate elements fastened, fixed, adhered, attached, welded, or mechanically coupled to the drum 505. The protrusions 515 of the drum 505 can have the same shape or different shapes than the protrusions 515 of the shaft 510. The protrusions 515 can be disposed in various patterns on the drum 505. For example, the protrusions 515 can be arranged in a number of annular or ring shaped patters around a radial distance of the drum 505 along the inner surface of the drum, or in a linear arrangement around the drum 505, or in a number of rows along a longitudinal axis or length of the drum 505. In one implementation, there are six rows of protrusions 515 extending from and along the longitudinal axis or length of the drum 505.

FIG. 14 depicts an example of the drum assembly 500 with the shaft 510 disposed in the cavity of the drum 505. In this example, the drum 505 and the shaft 510 both include the protrusions 515. The protrusions 515 can be arranged on the drum 505 and the shaft 515 so as not to contact each other during rotation of the shaft 510, of the drum 505, of both. For example, the protrusions 515 can have lengths short enough so that they do not contact each other in the cavity, or the protrusions of the drum 505 can be offset from the protrusions of the shaft 510 along the longitudinal length of the drum 505 and the shaft 510 so as to avoid contact with each other. For example, the protrusions 515 on the drum 505 can be spaced apart every three inches (or other distance) from each other, starting at a distance of 1.5 inches (or other distance) from at least one of the end plates 525, and the protrusions 515 on the shaft can also be spaced apart three inches from each other, but starting at a distance of 3 inches from at least one of the end plates. In this example, even if the lengths of the protrusions 515 are sufficient so that the protrusions pass each other along the radius of the drum 505, they are longitudinally offset from each other by about 1.5 inches, center to center. In some implementations, only the drum 505 includes the protrusions 515, or only the shaft 510 includes the protrusions 515.

The drum assembly 500 as well as its components (e.g. the drum 505 or the shaft 510) can include various protrusions 515 having different shapes. For example, one drum assembly 500 can include round, circular, symmetrical, asymmetrical, headed, or headless protrusions 515, or protrusions 515 having different lengths. In one implementation, each of the protrusions 515 in the drum assembly has the same size, shape, and length. In one implementation, the protrusions 515 from the drum 505 are longer than the protrusions 515 from the shaft 510. In one implementation, the protrusions 515 from the shaft 510 are longer than the protrusions 515 from the drum 505.

At least one drive unit 520 coupled to the shaft 510 can operate to apply mechanical force to the shaft 510, to rotate the shaft 510. The rotation can cause the protrusions 515 to rotate through the cavity, or internal space, of the drum 505. For example the drive unit 520 can include an AC or DC motor coupled to the shaft 510. Operation of the drive unit 520 can rotate the shaft 510. The drum assembly 500 can include end plates 525 at the distal or lateral ends of the drum 520 to support the drum 505 or components such as the shaft 510. In one implementation, the drive unit 520 is mounted to at least one end plate 525. At least one end plate 525 can include a window, door, or opening for insertion and removal of the produce 100. The drive unit 520 can also be mechanically coupled to but remote from the drum assembly 500. For example, the drive unit 220 (or other drive unit) can include the drive unit 520, and through a gear, belt or shaft system, the drive unit 220 can transfer mechanical force to the shaft 510 to rotate the shaft 510 and the protrusions 515. In one implantation, the protrusions 515 are attached to or an integral part of the end plates 525. For example, the protrusions 515 can include rods (polygonal, circular, or elliptical) that extend across a longitudinal length of the cavity of the drum 500 between the end plates 525, with the protrusions 515 connected to the end places 515 and not, for example, to the drum 505 or to the shaft 510.

The size of the drum 505 and the drum assembly 500 can vary. For example, the drum 505 can have a longitudinal length of less than three feet and a diameter of less than two feet. In some implementations, the drum 505 is larger and can be several feet or more in length. In some implementations, multiple drum assemblies operate simultaneously to process the produce 100. The capacity of the drum assembly 500 to process the produce 100 can vary from dozens of items of produce 100 (e.g., individual peppers) to hundreds or thousands of items of produce 100 during one load of the produce 100 into the drum 505.

In one implementation, the produce 100 in the partially separated state (e.g., after exiting the longitudinal gap 405) can be provided into the cavity of the drum 505, at least partially filling the cavity. During operation of the drum assembly 500 with the produce 100 disposed in the cavity of the drum 505, rotation of the shaft 510 (or the drum 505) causes the protrusions 515 to move through the cavity where the protrusions 515 contact the produce 100. The protrusions 515 can apply a blunt force to the produce 100. For example, the protrusions 515 can have the general shape of fins, as in FIGS. 5 and 6, (or other shape) and a broad surface of the fins can hit the produce 100 during rotation of the shaft 510. This contact can cause the fin (or other protrusion 515) to apply a blunt force to the produce 100. The blunt force can fully separate the first portion 105 of the produce 100 from the second portion 110 of the produce 100. For example, the blunt force from the protrusion 515 can separate the pod 115 from the stem 120 and at least a portion of the calyx 125. In this example, the stem 120, separated from the pod 115, may remain attached to at least part of the calyx 125. In some implementations, blunt force applied by other items of produce in the drum 505 during shaft rotation can separate the pod 115 from the stem 120 and at least a portion of the calyx 125. For example, different items of produce can hit each other during processing by the drum assembly 500. In one implementation, this contact between produce items (e.g., individual peppers) can generate the blunt force that separates the pod 115 from the stem 120 of an item of produce 100 in the absence of direct contact between that item of produce 100 and the protrusions 515. In this example, shaft 510 rotation indirectly generates the blunt force to separate the first portion 105 of the produce 100 from the second portion 110. The blunt force can be caused by drum 505, shaft 510, or protrusion 515 rotation. For example direct contact between these elements and the produce 100, or contact between different items of produce 100 in the absence of direct contact with these elements, or both, caused by the rotation can separate the pod 115 from the stem 120.

After processing by the drum assembly 500, the stem 120 and the calyx 125 can remain attached to each other and be separated from the pod 115, with the pod 115 intact (e.g., without cut, puncture, or rupture wounds that penetrate into the produce 100 or into any internal cavities of the produce 100). In this example, it is the compression force (e.g., from the de-stemming apparatus 200) and the blunt force (e.g., from the drum assembly 500), and not a cutting blade, water jet, or air blade (e.g., concentrated air flow) that separates the first portion 105 of the produce 100 from the second portion 110.

In one implementation, the shaft 510 and the fins or other protrusions 515 remain fixed, and the drum 505 is coupled with the drive unit 520 to rotate around the shaft 510, with the shaft in a fixed position, to bring the produce into contact with the protrusions 515. In one implementation the protrusions 515 protrude inward into the drum cavity from an inner surface of the drum 505, rather than outward from the shaft 510.

In one implementation, between processing by the de-stemmer 200 and the drum assembly 500, the produce 100 is processed by at least one dryer unit. For example, the pressed and partially separated produce 100 can exit the longitudinal gap and be automatically or manually conveyed to a dryer unit to dry the produce 100 to a determine moisture content. Once dried, the produce 100 can be manually or automatically conveyed from the dryer unit to the drum assembly for total separation of the first portion 105 of the produce 100 from the second portion 110 of the produce 100. The dryer unit can include an electric or gas powered air blower or hot air conveying unit to dry the produce 100. On an industrial scale where the de-stemming apparatus 200 and the drum assembly 500 are configured for high volume processing, the dryer unit can dry the produce 100 at a rate of approximately one metric ton per hour.

In some implementations, the de-stemming apparatus 200 and the drum assembly 500 (which may also be considered part of the de-stemming apparatus 200) are part of a system of processing (e.g., de-stemming) the produce 100. For example, the de-stemming apparatus 200 can include at least two roller pairs in a stacked configuration that define the longitudinal gap 405. The drive unit 220 can rotate at least one roller 205a, 205b of one or more of the roller pairs. For example, the drive unit can rotate rollers 205a in the direction 235 and rotate rollers 205b in the opposite direction 240. The rotation of the roller pairs can pass the produce 100 into, through, and out of the longitudinal gap 405 (e.g., in the direction of motion 245). In some implementations, the radial distance 410 at an entry point of the longitudinal gap 405 is greater than the radial distance 410 at an exit point of the longitudinal gap 405. The rollers 205a, 205b of at least one roller pair can apply a compression force to at least part of the produce 100, such as an area of the produce 100 that includes the calyx 125. The compression force can loosen (e.g., partially separate) the pod 115 from the calyx 125 and the stem 120, with the stem 120 attached to the calyx 125. In this example, the compression force can weaken the connection between the first portion 105 and the second portion 110 of the produce 100. The drum assembly 500 can receive the produce 100 in the loosened state after the produce 100 exits the longitudinal gap 405. The protrusions 515 of the drum assembly shaft 510 can apply a blunt force to the produce 100 in the drum 505, for example when the drive unit 520 rotates the shaft 510 to move the protrusions 515. The blunt force can separate the pod 115 (or other first portion 105) from at least a portion of the stem 120 and the calyx 125 (or other second portion 110) of the produce 100.

In some implementations, at least one manual operator, produce feeder unit, or produce alignment apparatus (not shown in FIG. 2) can provide the produce 100 for entry into the de-stemming apparatus 200, e.g. into the longitudinal gap 405. For example, a feeder unit proximate to or coupled with the de-stemming apparatus 200 can include a rectangular hopper or conveyor belt system with mechanical features or image recognition features to align peppers or other produce for placement between rollers 205a, 205b of a roller pair. The produce 100 aligned in this manner can be conveyed by the de-stemming apparatus 200 (e.g., by rotations forces of the rollers 205a, 205b) in the direction of motion 245. The feeder unit can also remove dirt, stones, and other plant debris form the produce 100.

In one implementation, a worker can manually remove the first portion 105 of the produce 100 from the drum assembly 500 subsequent to separation of at least part of the second portion 110 from the first portion 105. The second portion 110 or portion thereof can be expelled from the drum assembly 500 via a door, window, or opening in the drum 505, removed by a conveyance system, or manually taken from the drum assembly 500 by a manual laborer. At least a portion of the stem 120 or the calyx 125 can fall into a box for onto another conveyor unit for further processing, recycling, or disposal.

FIG. 9 illustrates one example of the produce 100 subsequent to separation of the second portion 110 from the first portion 105 by the de-stemming apparatus 200 and (or including) the drum assembly 500. In one implementation, the de-stemming apparatus 200 at least partially separates at least part of the second portion 110 from the remainder of the produce 100 and the drum assembly can complete the separation. For example, all or part of the stem 120 and the calyx 125 can be separated from the body or pod 115. In some implementations, the pod 115 remains substantially intact after separation from the stem 120 or calyx 125. For example, due to the compression force based loosening and blunt force based separation, the pod 115 (or other first portion 105 of an item of produce 100) can be substantially free of punctures, tears, penetrations, or cut marks. In one implementation, the successive compression and blunt forces cause separation between the calyx 125 and the pod 115. In some implementations, the compression and blunt forces cause separation between at least part of the stem 115 and the remainder of the produce 100. In one implementation the produce 100 may have a minimal or no calyx 125, and the separation can occur between the stem 120 and the pod 115.

In some implementations, each of the roller pairs can be in simultaneous motion. The roller pairs can be driven by the same or different driving units 220, and one driving unit 220 can drive one or more of the roller pairs at the same speed (e.g., within +/−10%). In one implementation, one driving unit 220 drives each of the rollers 205a, 205b. In one implementation, at least one of the rollers 205a, 205b can be passive, e.g., not actively driven by the driving unit 220. For example, some of the rollers 205a, 205b can include bearings that are not driven by any of the driving units 220 and that can rotate or spin to allow at least a portion of the produce 100 to pass the passive rollers 205a, 205b.

The de-stemming apparatus 200, including or with the drum assembly 500 can de-stem produce 100 in a low or high volume environment. For example, the de-stemming apparatus 200 can be part of a volume production plant in an assembly line type environment where a high volume of produce 100 (e.g., between 500 and 2500 pounds of produce per hour) is processed (e.g., at least partially de-stemmed) by the de-stemming apparatus 200. The de-stemming apparatus 200 can also be a portable or semi-portable unit that can be set up outside a factory or mass production environment, such as outside in a field or farm sufficiently close to a crop so that a harvester (or harvesting machine) can pick the produce 100 and feed the produce 100 to the de-stemming apparatus 200, e.g., by placing the produce tip first into the longitudinal gap 405. The de-stemming apparatus 200 can process multiple items of produce 100 simultaneously, with different items of produce 100 in different stages of the de-stemming process during sequential conveyance through the de-stemming apparatus 200.

FIG. 10 is a flow diagram illustrating a method 1000 of processing produce, according to an implementation. The method 1000 can align the produce for entry into the de-stemming apparatus 200 (ACT 1005). For example, guide plate, ramp, funnel, or feeder unit can provide the produce 100 for entry into the de-stemming apparatus, e.g., into the longitudinal gap 405 between rollers 205a, 205b of a pair or rollers. The produce can be provided for entry in any orientation. In one implementation, the produce 100 is aligned (ACT 1005) for a tip first entry into the longitudinal gap, with a longitudinal axis of the produce being substantially (e.g., +/−10%) vertical.

The method 1000 can convey the produce 100 through the de-stemming apparatus 200 (ACT 1010). For example, opposite rotation of rollers 205a, 205b of at least one roller pair, driven by the drive unit 220, can move the produce 100 through the longitudinal gap. During conveyance through the longitudinal gap 405, the method can apply a compression force (ACT 1015). The longitudinal gap 405 can be generally vertically oriented, e.g., within 20 degrees of the vertical axis 420. The compression force can be applied by two rollers 205a, 205b or a roller pair having a radial distance 410 of less than a diameter or cross sectional width of the produce 100. The applied compression force (ACT 1015) can partially separate the first portion 105 of the produce 100 from the second portion 110 of the produce 100.

The method 1000 can provide the produce 100 to at least one dryer unit (ACT 1020). The dryer unit can be natural (e.g., relying on ambient light or wind, for example in a drying room or hanging room configuration), or automated, (e.g., a machine configured to blow hot or dry air past the produce 100). The (loosened or partially separated) produce 100 can be provided to the dryer unit (ACT 1020) manually or by automated conveyance from an exit point of the longitudinal gap 405 into the dryer unit. The method 1000 can receive the produce in the drum assembly 500 (ACT 1025). For example, the produce can be manually or automatically conveyed from the de-stemming apparatus 200 (e.g. once exiting the longitudinal gap 405 in the partially separated or loosened state) or from the dryer unit to the drum assembly 500.

The method 1000 can rotate the shaft 510 of the drum assembly 500 to move the protrusions 515 through the cavity of the drum 505 (ACT 1030). Rotating the shaft 510 (ACT 1030) can cause the protrusions 515 of the shaft or of the drum to apply a blunt force to the (loosened or partially separated) produce 100 to fully separate at least the stem 120 form the pod 115, or the first portion 105 of the produce 100 from the second portion 110.

In some implementations, the de-stemming apparatus 200 and the drum assembly 500 are part of a system of de-stemming the produce 100 having the first portion 105 and the second portion 110. The system can include a plurality of roller pairs 205. The rollers 205 of the pairs can define the longitudinal gap 405, and the rollers 205 can rotate to convey the produce 100 through the longitudinal gap 405 and in so doing can apply a compression force to the produce 100. The drum assembly 500 can include at least one drum 505 and at least one shaft 510, at least one of which may include the protrusions 515. The produce can be placed, driven, or conveyed into a cavity of the drum 505. The drive unit 520 or other source of electrical or mechanical power can rotate the drum 505 or the shaft 510. The rotation can cause the protrusions 515 to hit the produce 100 disposed in the cavity of the drum 505. The blunt force applied by at least the protrusions 515 to the produce 100 can at least partially separate the first portion 105 of the produce 100 from the second portion 110 of the produce 100.

The protrusions 515 can protrude at various angles from the shaft 510 or the drum 505. For example, the protrusions 515 can protrude at a right angle from an outer surface of the shaft. In some implementations, the protrusions 515 protrude at an angle of between 60 and 120 degrees from an outer surface of the shaft 510. The protrusions 515 can also protrude into the cavity of the drum 505, from an inner surface of the drum 505 within +/−30 degrees of a radial axis of the cavity (e.g., of the drum 505). In some implementations, the outer surface of the shaft 510 and the inner surface of the drum 505 define the endpoints of a radial distance of the cavity. The protrusions 515 can have a length of less than 50% of this radial distance, or of greater than 50% of this radial distance. The protrusions 515 can protrude from both the shaft 510 and from the drum 505 into the cavity (e.g., into the interior of the drum 505, or the open space between the outer surface of the shaft 510 and the inner surface of the drum 505).

The produce 100 can include the pod 115, the stem 120, and the calyx 125. The rollers 205 of roller pairs can be arranged in a stacked configuration to define at least part of the longitudinal gap 405. The rollers 205 can pass (e.g., guide or drive) the produce through the longitudinal gap 405 from an entry opening of the longitudinal gap 405 to an exit opening of the longitudinal gap 405. The entry opening can have a larger area than the exit opening. For example, the longitudinal gap 405 can get smaller along or down the direction of motion 245 or along the vertical axis 420. In some implementations, a first roller (e.g., roller 205a) of the rollers 205 can roll in a first direction (e.g., clockwise from a perspective) and a second roller (e.g., roller 205b) of the rollers 205 can roll in a second direction that is opposite from or different than the first direction (e.g., counterclockwise from the same perspective). The opposing motion of respective rollers 205 can pass the produce 100 through at least part of the longitudinal gap 405 and, for example, the motion and narrowing characteristics of the longitudinal gap 405 can apply a compression force to the produce 100. The compression force can loosen the pod 115 from the calyx 125 or the stem 120, for example with the stem 120 attached to the calyx 125.

The produce 100, for example in the loosened state, can be disposed in the drum assembly 500. The drive unit 520 (or other source of power or motion) can cause at least part of the drum assembly 500 (e.g., the shaft 510 or the drum 505) to rotate. The rotation can cause the protrusions 515 or other components of the drum assembly 500 such as the inner surface of the drum 505, the shaft 510, or other obstacles to apply a blunt force to the produce 100 to separate the pod 115 from at least a portion of the stem 120 or the calyx 125.

In some implementations, the de-stemming apparatus 200, which may include the drum assembly 500 can at least partially de-stem the produce 100. For example, the rollers 205 can define the longitudinal gap 405. and can rotate to pass the produce through the longitudinal gap 405 and to apply a compression force to the produce 100. The drum assembly 500 can include the drum 505 that at least partially defines a cavity that can receive the produce 100. The drum assembly 500 can also include the shaft 510 at least partially disposed in the cavity. The drum 505 and the shaft 510 can each include at least one protrusion 515. The drive unit 520 can be directly or indirectly (e.g., with intervening components) coupled to the drum assembly 500. For example, the drive unit 520 can be coupled with the shaft 510 to rotate at least part of the drum assembly 500 (e.g., the shaft 510 or the drum 505) to apply a blunt force to the produce 100. The blunt force can separate or loosen the first portion 105 of the produce from the second portion 110 of the produce 100. The protrusions from the drum 505 and the shaft 510 can have, for example, an annular configuration around the inner surface of the drum 505 and around an outer surface of the shaft 510.

The system or apparatus including the de-stemming apparatus 200 or the drum assembly 500 can be part of a method of processing the produce 100. For example the de-stemming apparatus 200 can convey the produce 100 (or at least one item or individual unit of produce 100) through the longitudinal gap 405 and between rollers 205 to apply a compression force to the produce 100. The produce 100 can be conveyed through the longitudinal gap 405 into the cavity of the drum assembly 500. The drum assembly 500 can include the drum 505 or the shaft 510. The drum 505 or the shaft 510 can have at least one protrusion 515 extending into the cavity. The drive unit can rotate at least part of the drum assembly 500 to toss or tumble the produce 100 within the cavity, where blunt forces from contact between the produce 100 and the protrusions 515 (or other components of the drum assembly 500) separate the first portion 105 or the produce from the second portion 110 of the produce 100. The produce can be expelled or removed from the cavity via a temporary or permanent opening, door, or window in the drum 505 or other portion of the drum assembly that forms the cavity, such as the end plates 525. For example a temporary opening can be closed automatically or manually. A permanent opening can be fixed open, such as a cutaway of part of the drum 505, for example.

FIG. 15 is a flow diagram illustrating a method 1500 of processing produce, according to an implementation. The method 1500 can provide the produce 100 such as peppers (ACT 1505). For example, the produce 100 can be provided in a state with the first portion 105 and the second portion 110 attached to each other. The method 1500 can convey the produce between at least two rollers 205 (ACT 1510). For example, two of the rollers 205 can rotate in opposite directions to move or convey the produce through a longitudinal gap between the two rollers 205 (e.g., in the direction of motion 245 or along the vertical axis 420).

The method 1500 can convey the produce 100 into a cavity of the drum assembly 500 (ACT 1515). The produce 100 can be placed or dropped into the cavity manually, via conveyor belts or other mechanical elements or combinations thereof. The produce can drop or be expelled from the longitudinal gap between rollers 205 where it can drop directly into the cavity, be carried into the cavity by at least one conveyor belt, or be manually placed into the cavity. The method 1500 can rotate at least part of the drum assembly 500 (ACT 1520). For example the drive unit 520 can rotate the shaft 510 or the drum 505. In some examples, the drive unit 520 rotates the shaft 520, and the shaft is coupled to the drum causing the drum 505 to rotate. For example, the shaft 520 can be fixed to the drum 505 so that, rather than spinning within the drum 505 with the drum 505 in a fixed position, the force applied to the shaft is transferred to the drum so that the shaft 520 and the drum 505 spin together, for example at substantially a same (e.g., within +/−10%) number of revolutions per minute. When, for example, the produce 100 is disposed in the cavity of the drum assembly 500 (e.g., a cavity formed at least in part by the drum 505), the protrusions 515 of the shaft 510, the drum 505, or both can hit the produce 100, imparting a blunt force on the produce 100 that can separate the first portion 105 of the produce from the second portion 110 of the produce, (e.g., can separate the pod 115 from the stem 120 and at least part of the calyx 125).

The method 1500 can expel the produce 100 from the drum assembly 500 (ACT 1525). For example, the drum 505 can include a permanent opening that the produce will fall out of, or a door or window that can be opened and closed automatically or manually for retrieval of the produce 100. The produce 100 expelled from the drum assembly can be in a separated state, with the first portion 105 detached from the second portion 110.

The operations described in this specification can be implemented as operations performed by a data processing apparatus on data stored on one or more computer-readable storage devices or received from other sources. For example, the driving units 220 or 520 can include control circuitry (e.g., at least one processor or application specific integrated circuit) that operates the driving unit to move at least one of the rollers 205a, 205b, the drum 505, or the shaft 510.

Features that are described herein in the context of separate implementations can also be implemented in combination in a single embodiment or implementation. Features that are described in the context of a single implementation can also be implemented in multiple implementations separately or in various sub-combinations. Moreover, although features may be described above as acting in certain combinations and even initially claimed as such, one or more features from a claimed combination can in some cases be excised from the combination, and the claimed combination may be directed to a sub combination or variation of a sub combination.

Similarly, any acts depicted in the drawings should not be understood as requiring performance in the particular order shown or in sequential order, or that all illustrated acts be performed, to achieve desirable results. Actions recited in the claims can be performed in a different order and still achieve desirable results. In addition, the processes depicted in the accompanying figures do not necessarily require the particular order shown, or sequential order, to achieve desirable results.

Any references to front and back, left and right, top and bottom, or upper and lower and the like are intended for convenience of description, not to limit the present systems and methods or their components to any one positional or spatial orientation.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementation,” “an alternate implementation,” “various implementation,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. For example, specific references to a pod can include generic references to any first or generally edible portions of produce, and specific references to any stem or calyx include generic references to any second or generally uneaten portions of produce. Generic references to a first portion of produce include references to generally edible portions such as a pod or body, and generic references to a second portion of produce include references to generally uneaten portions such as a stem or calyx. Further, while not labeled in every Figure for clarity and ease of description, elements present and labeled in one Figure may be present and unlabeled in other Figures. Further, while referred to as a de-stemming apparatus, the de-stemming apparatus 200 can remove portions of items of produce other than stems, such as leaves, branches, or other support structures or appendages of an item of produce. Further references to the first roller pair or second roller pair do not limit the roller pair to a position in the de-stemming apparatus 200. For example, with reference to FIG. 2, the first roller pair need not be the top roller pair. Further, the drum assembly 500 can have various designs. For example, the shaft 510 need not protrude through the cavity of the drum 505. For example, the shaft 510 can coupled the drive unit 520 to the drum 505 (e.g., via gears or a device to apply translational force) to rotate the drum 505 without the shaft protruding partially or completely through the cavity of the drum. In this example, the protrusions 515 can protrude from the inner surface of the drum 505 or not from the shaft 510.

The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

1. A system of de-stemming produce having a first portion and a second portion, comprising:
a plurality of roller pairs defining a longitudinal gap between individual rollers of the roller pairs;
the plurality of roller pairs configured to rotate to pass the produce through the longitudinal gap and apply a compression force to the produce;
a drum assembly having at least one of a shaft and a drum, at least one of the shaft and the drum including a plurality of protrusions configured to apply a blunt force to the produce to at least partially separate the first portion from the second portion.

2. The system of claim 1, comprising:
at least one of the plurality of protrusions protrude at one of a right angle and an angle of between 60 degrees and 120 degrees from an outer surface of the shaft.

3. The system of claim 1, comprising:
the drum at least partially defining a cavity; and
at least one of the plurality of protrusions protruding from an inner surface of the drum within 30 degrees of a radial axis of the cavity.

4. The system of claim 1, comprising:
an outer surface of the shaft and an inner surface of the drum defining a radial distance of a cavity; and
each of the plurality of protrusions having a length of less than 50% of the radial distance.

5. The system of claim 4, comprising:
a first protrusion of the plurality of protrusions disposed on the shaft and extending into the cavity; and
a second protrusion of the plurality of protrusions disposed on the inner surface of the drum and extending into the cavity.

6. The system of claim 1, comprising:
an outer surface of the shaft and an inner surface of the drum defining a radial distance of a cavity; and
each of the plurality of protrusions having a length of at least 50% of the radial distance.

7. The system of claim 6, comprising:
a first protrusion of the plurality of protrusions disposed on the shaft and extending into the cavity; and
a second protrusion of the plurality of protrusions disposed on the inner surface of the drum and extending into the cavity.

8. The system of claim 1, wherein the first portion of the produce includes a pod, and the second portion of the produce includes a stem and a calyx, comprising:
the plurality of roller pairs having a stacked configuration defining the longitudinal gap;
the plurality of roller pairs configured to pass the produce through the longitudinal gap from an entry opening of the longitudinal gap to an exit opening of the longitudinal gap, the entry opening having area that is greater than an area of the exit opening;
a first roller of the plurality of rollers configured to rotate in a first direction and a second roller of the plurality of rollers configured to rotate in a second direction opposite the first direction to pass the produce through at least a portion of the longitudinal gap and to apply at least a portion of the compression force to loosen the pod from the calyx and the stem with the stem attached to the calyx; and
the drum assembly configured to rotate to apply the blunt force to the produce to separate the pod from at least a portion of the calyx and the stem.

9. The system of claim 1, comprising:
the drum including at least one protrusion of the plurality of protrusions, the at least one protrusion extending into a cavity of the drum from an inner surface of the drum.

10. The system of claim 1, comprising:
the shaft including at least one protrusion of the plurality of protrusions, the at least one protrusion extending into a cavity of the drum from the shaft.

11. The system of claim 1, comprising:
the shaft including a first protrusion of the plurality of protrusions; and
the drum including a second protrusion of the plurality of protrusions.

12. The system of claim 1, comprising:
a drive unit configured to rotate at least one of the shaft and the drum to bring the produce into physical contact with at least one of the plurality of protrusions to apply the blunt force.

13. The system of claim 1, wherein a cross sectional shape of at least one of the plurality of protrusions is one of square, quadrilateral, triangular, circular, elliptical, and ovoid.

14. The system of claim 1, wherein at least one of the plurality of protrusions is an asymmetrical protrusion, a linear protrusion, a non-linear protrusion, a protrusion having multiple linear segments, and a protrusion having a longitudinal portion and a head portion.

15. The system of claim 1, comprising:
a first protrusion of the plurality of protrusions having a first length; and
a second protrusion of the plurality of protrusions having a second length different than the first length.

16. The system of claim 1, comprising:
at least some of the plurality of protrusions disposed in a ring around at least one of an inner surface of the drum and an outer surface of the shaft.

17. A de-stemming apparatus for at least partially de-stemming produce having a first portion and a second portion, comprising:
a plurality of rollers defining a longitudinal gap;
the plurality of rollers configured to rotate to pass the produce through the longitudinal gap and apply a compression force to the produce;
a drum assembly having a drum at least partially defining a cavity and a shaft at least partially disposed in the cavity, the drum having a protrusion extending into the cavity, and the shaft having a protrusion extending into the cavity;
a drive unit configured to rotate at least part of the drum assembly to apply a blunt force to the produce.

18. The de-stemming apparatus of claim 17, comprising:
the drum having a first plurality of protrusions extending from the drum into the cavity, at least some of the first plurality of protrusions in an annular configuration around the drum; and
the shaft having a second plurality of protrusions extending from the shaft into the cavity, at least some of the second plurality of protrusions in an annular configuration around the shaft.

19. A method of processing produce, comprising:
conveying an item of produce having a first portion and a second portion through a gap between a first roller and a second roller to apply a compression force to the item of produce;
conveying the item of produce from the gap between the first roller and the second roller into a cavity of a drum assembly having at least one of a drum and a shaft, at least one of the drum and the shaft having a protrusion extending into the cavity;
rotating at least part of the drum assembly to apply a blunt force from the protrusion to the item of produce to separate the first portion of the produce from the second portion of the produce.

20. The method of claim 19, comprising:
providing the item of produce for entry into the gap; and
conveying the item of produce into the cavity of the drum assembly; and
expelling the item of produce from the cavity of the drum assembly.
